(19) United States
(12) Patent Application Publication
(10) Pub. No.: US 2021/0387235 A1
(43) Pub. Date: Dec. 16, 2021

(54) TILTING-PAN TYPED SORTING MACHINE

(71) Applicant: GUANGDONG LISHENG INTELLIGENT CO., LTD., DONGGUAN (CN)

(72) Inventors: JIANMAN HUANG, DONGGUAN (CN); ZHIWU HU, DONGGUAN (CN); GAOQIANG ZHANG, DONGGUAN (CN)

(21) Appl. No.: 17/458,621

(22) Filed: Aug. 27, 2021

Related U.S. Application Data
(63) Continuation of application No. PCT/CN2020/072613, filed on Jan. 17, 2020.

(30) Foreign Application Priority Data
Feb. 28, 2019 (CN) 201910148557.2

(51) Int. Cl. B07C 3/08; B65G 47/96

(52) U.S. Cl. CPC B07C 3/08; B65G 47/96

(57) ABSTRACT

The present invention relates to the technical field of automation apparatuses, in particular, to a tilting-pan typed sorting machine, including a frame body, a code reading device, an unloading device, a reset track, and a sorting sliding slot, where an operation track is disposed on the frame body; the code reading device is disposed above the operation track; the unloading device is disposed below the operation track; the reset track is disposed below the operation track; several tilting-pan trolleys are disposed on the operation track; a side of the operation track is further provided with a linear motor; and the sorting sliding slot is disposed at two sides of the unloading device of the operation track. The linear motor is adopted for driving main line operation, and a pure mechanical structure design is adopted for a sorting bogie unloading and reset mechanism;

### TECHNICAL FIELD

The present invention relates to the technical field of automation apparatuses, in particular, to a tilting-pan typed sorting machine.

### BACKGROUND

The tilting-pan typed sorting machine can meet high efficiency sorting and delivery requirements in multiple industries; and is controlled by connecting to a Warehouse Control System (WCS) of an entire logistics system. An item to be sorted can be automatically imported through a transmission apparatus or manually imported by an operator into the sorting machine. The sorting machine executes sorting control through control software, and sorts the item to a set outlet, which enters the corresponding transmission container through free falling or through a sliding slot.

The existing tilting-pan typed sorting machine has a single design and simple functions. During usage, the following problems would occur: low working efficiency, weak adaptability, hard adjustment, unstable usage, and inconvenient maintenance, thus failing to meet the industrial requirements.

### SUMMARY

The purpose of the present invention is to provide a tilting-pan typed sorting machine for the disadvantages in the prior art. The structure thereof is scientifically designed. Upon comparison with a cross-belt sorting machine with the same configuration, a plurality of adopted tilting-pan trolleys with unique “one-trolley-two-pan” structure greatly improve sorting efficiency, and greatly reduce apparatus costs. An adopted tray-typed carrying structure has extremely strong sorting adaptability, stable performance, and convenient usage. The apparatus is operated in a low rate, which is more suitable for a manual package supply mode and does not require multi-stage package supply systems. At the same time, a mouth sliding slot and a track door frame are integrally designed, and thus the system has a compact structure and a flexible arrangement, and reduces occupation of land. A linear motor is adopted for driving main line operation, and a pure mechanical structure design is adopted for a sorting bogie unloading and reset mechanism; and the whole set of apparatuses is extremely low in energy consumption.

To implement the purpose above, the present invention adopts the following technical solution: a tilting-pan typed sorting machine includes a frame body, a code reading device, an unloading device, a reset track, and a sorting sliding slot. An operation track is disposed on the frame body; the code reading device is disposed above the operation track; the unloading device is disposed below the operation track; the reset track is disposed below the operation track; several tilting-pan trolleys are disposed on the operation track; a side of the operation track is further provided with a linear motor; and the sorting sliding slot is disposed at two sides of the unloading device of the operation track.

The tilting-pan trolley includes a trolley frame; four universal walking wheels disposed at equal altitude and in parallel are disposed at lower parts of two ends of the trolley frame; two guiding wheels are further disposed at a lower part of an end of the trolley frame; a joint bearing is disposed at an upper part of the end of the trolley frame having the guiding wheels; a linear motor secondary plate is disposed on an inner side of the end of the trolley frame having the guiding wheels; a tilting-pan seat, a right seat plate, and a left seat plate are disposed on the trolley frame; the right seat plate and the left seat plate are disposed at two sides of the tilting-pan seat; two short connection rods are movably hinged on the tilting-pan seat; a sliding seat is disposed on both the right seat plate and the left seat plate; a lifting rod is disposed in the middle of the sliding seat; two buffers are further disposed on the sliding seat; and the buffers are symmetrically distributed at two sides of the lifting rod.

The lifting rod is T-shaped; a T-shaped end of the lifting rod is movably hinged with a long connection rod; an end of the long connection rod is movably hinged with the short connection rod; and the long connection rod is provided with a tilting pan.

A rotation shaft and two limiting rods are disposed at lower parts of both the right seat plate and the left seat plate; the two limiting rods are disposed at two sides of the rotation shaft; a rotation rod is disposed at a lower end of the rotation shaft; a spring is further disposed at lower parts of the right seat plate and the left seat plate; and the other end of the spring is hinged with the rotation rod.

A locking wheel and a reset wheel are successively disposed at a lower end of the lifting rod from top to bottom; a bearing is disposed both in the middle of the locking wheel and in the middle of the reset wheel; and surfaces thereof are both made of an MC nylon material with lightweight and wear resistance.

The unloading device includes an air cylinder seat; the air cylinder seat includes two symmetrically disposed unloading air cylinders; a piston rod of each unloading air cylinder is provided with an unloading wheel; the two unloading wheels are disposed in parallel.

The tilting-pan trolleys are head-to-tail connected through the joint bearing.

The tilting pans on each tilting-pan trolley are all disposed in a symmetrical pair.

The walking wheels at the two ends are four universal wheels disposed at equal altitude and in parallel.

The reset track consists of two slope tracks disposed in parallel.

The beneficial effects of the present invention are as follows: A tilting-pan typed sorting machine includes a frame body, a code reading device, an unloading device, a reset track, and a sorting sliding slot, where an operation track is disposed on the frame body; the code reading device is disposed above the operation track; the unloading device is disposed below the operation track; the reset track is disposed below the operation track; several tilting-pan trolleys are disposed on the operation track; a side of the operation track is further provided with a linear motor; and the sorting sliding slot is disposed at two sides of the unloading device of the operation track. Upon comparison with a cross-belt sorting machine with the same configuration, a plurality of adopted tilting-pan trolleys with unique “one-trolley-two-pan” structure greatly improve sorting efficiency. An adopted tray-typed support structure has extremely strong sorting adaptability, stable performance, and convenient usage. The apparatus is operated in a low rate, which is more suitable for a manual package supply mode and does not require multi-stage package supply systems. At the same time, a mouth sliding slot and a track door frame are integrally designed, and thus the system has a compact structure and a flexible arrangement, and reduces occupation of land. The linear motor is adopted for driving main line operation, and a pure mechanical structure design is adopted for a sorting bogie unloading and reset mechanism; and the whole set of apparatuses is extremely low in energy consumption.

### BRIEF DESCRIPTION OF DRAWINGS

FIG. 1 is a schematic structural diagram of the present invention.

FIG. 2 is a schematic structural diagram of another direction of the present invention.

FIG. 3 is a schematic structural diagram of a tilting-pan trolley of the present invention.

FIG. 4 is a schematic structural diagram of another direction of the tilting-pan trolley of the present invention.

FIG. 5 is an enlarged view of A in FIG. 2 of the present invention.

FIG. 6 is a schematic diagram of a reset track of the present invention.

### DESCRIPTION OF EMBODIMENTS

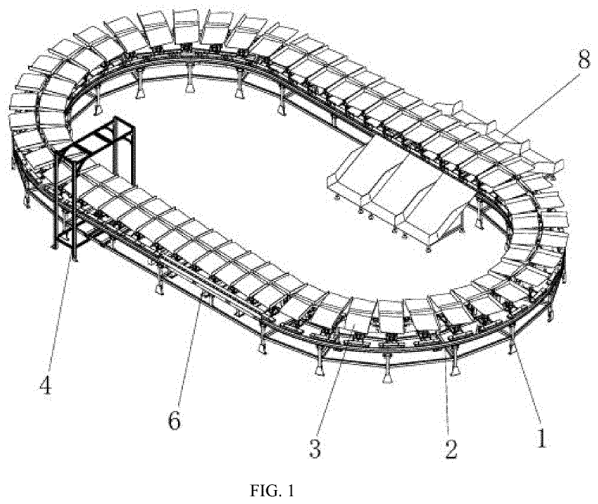

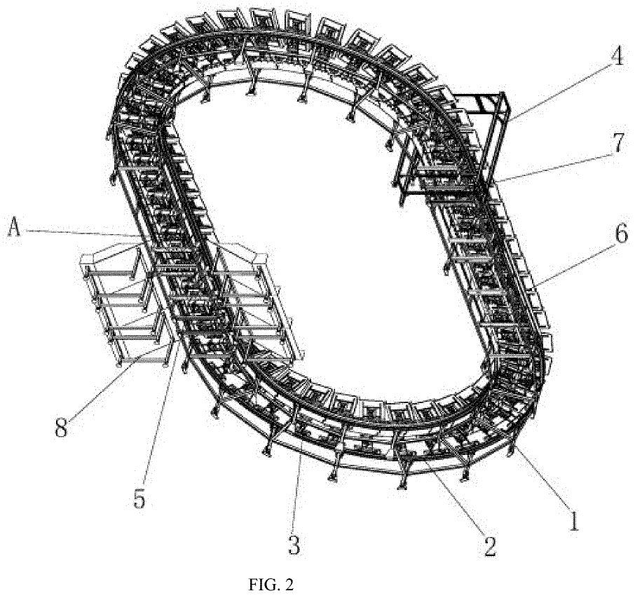

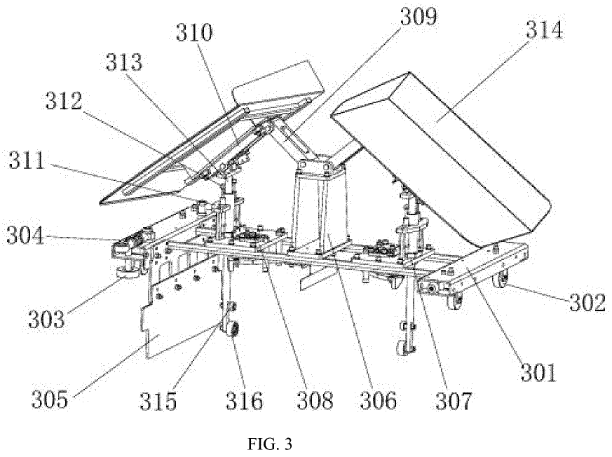

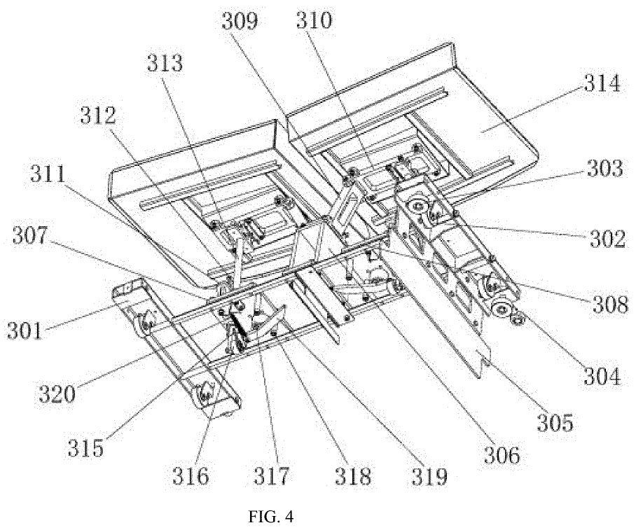

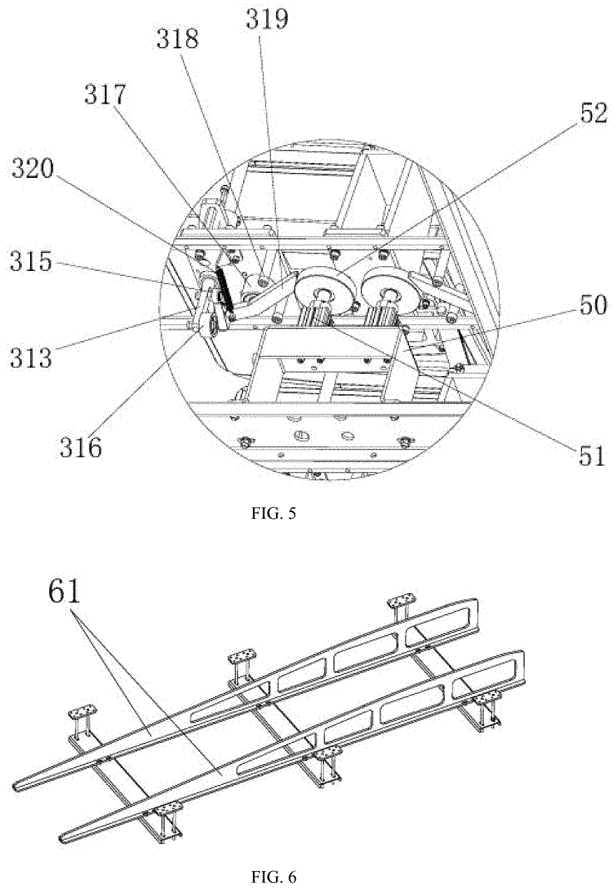

As shown in FIG. 1 to FIG. 6, a tilting-pan typed sorting machine of the present invention includes a frame body 1, a code reading device 4, an unloading device 5, a reset track 6, and a sorting sliding slot 8. An operation track 2 is disposed on the frame body 1; the code reading device 4 is disposed above the operation track 2; the unloading device 5 is disposed below the operation track 2; the reset track 6 is disposed below the operation track 2; several tilting-pan trolleys 3 are disposed on the operation track 2; a side of the operation track 2 is further provided with a linear motor 7; and the sorting sliding slot 8 is disposed at two sides of the unloading device 5 of the operation track 2. For the whole set of apparatuses, a mouth sliding slot and a track door frame are integrally designed, and thus it has a compact structure and a flexible arrangement, and reduces occupation of land.

The tilting-pan trolley 3 includes a trolley frame 301; four universal walking wheels 302 disposed at equal altitude and in parallel are disposed at lower parts of two ends of the trolley frame 301; two guiding wheels 303 are further disposed at a lower part of an end of the trolley frame 301; a joint bearing 304 is disposed at an upper part of the end of the trolley frame 301 having the guiding wheels 303; a linear motor secondary plate 305 is disposed on an inner side of the end of the trolley frame 301 having the guiding wheels 303; a tilting-pan seat 306, a right seat plate 307, and a left seat plate 308 are disposed on the trolley frame 301; the right seat plate 307 and the left seat plate 308 are disposed at two sides of the tilting-pan seat 306; two short connection rods 309 are movably hinged on the tilting-pan seat 306; a sliding seat 311 is disposed on both the right seat plate 307 and the left seat plate 308; a lifting rod 313 is disposed in the middle of the sliding seat 311; two buffers 312 are further disposed on the sliding seat 311; and the buffers 312 are symmetrically distributed at two sides of the lifting rod 313. The lifting rod 313 is T-shaped; a T-shaped end of the lifting rod 313 is movably hinged with a long connection rod 310; an end of the long connection rod 310 is movably hinged with the short connection rod 309; and the long connection rod 310 is provided with a tilting pan 314. Upon comparison with a cross-belt sorting machine with the same configuration, a plurality of adopted tilting-pan trolleys with unique “one-trolley-two-pan” structure greatly improve sorting efficiency, and greatly reduce apparatus costs, and have stable performance.

A rotation shaft 317 and two limiting rods 318 are disposed at lower parts of both the right seat plate 307 and the left seat plate 308; the two limiting rods 318 are disposed at two sides of the rotation shaft 317; a rotation rod 319 is disposed at a lower end of the rotation shaft 317; a spring 320 is further disposed at lower parts of the right seat plate 307 and the left seat plate 308; and the other end of the spring 320 is hinged with the rotation rod 319. A core control position of the apparatus is mechanically controlled through a spring, which thus has a low fault rate and can be conveniently used.

A locking wheel 315 and a reset wheel 316 are successively disposed at a lower end of the lifting rod 313 from top to bottom; a bearing is disposed both in the middle of the locking wheel 315 and in the middle of the reset wheel 316. This provides high flexibility; and moreover, surfaces thereof are both made of an MC nylon material with lightweight and wear resistance, thereby achieving the effects of lightweight and wear resistance.

The unloading device 5 includes an air cylinder seat 50; the air cylinder seat 50 includes two symmetrically disposed unloading air cylinders 51; a piston rod of each unloading air cylinder 51 is provided with an unloading wheel 52; and the two unloading wheels 52 are disposed in parallel. The unloading air cylinders 51 at both sides can rapidly control a position where a commodity is about to fall when unloading the commodity, which is highly efficient and accurate.

The tilting-pan trolleys 3 are head-to-tail connected through the joint bearing 304, so that the linear motor 7 thereof controls all tilting-pan trolleys 3 to automatically walk stably and orderly.

The tilting pans 314 on each tilting-pan trolley 3 are all disposed in a symmetrical pair, thereby ensuring action harmony of the tilting pans 314 at both sides, and improving working efficiency and stability.

The walking wheels 302 at the two ends are four universal wheels disposed at equal altitude and in parallel, so as to enable the tilting-pan trolleys 3 thereof to automatically and stably walk on the operation track 2, and to smoothly pass through an arc-shaped track during turning, thereby improving automation performance.

The reset track 6 consists of two slope tracks 61 disposed in parallel. When the tilting-pan trolley 3 walks through a working cycle, the tilting pans 314 thereof are automatically reset at the reset track 6; mechanical structure controlling reduces energy consumption and reduces the fault rate.

The operation mode: the main line of this apparatus is driven by the linear motor 7; the tilting-pan trolleys 3 are head-to-tail connected through the joint bearing 304 to form a closed ring shape. An item is placed on the tilting pan 314 manually or through an automatic package supply device. An identification code of the item is read through the code reading device 4 to obtain grid mouth information. The tilting-pan trolley 3 reaches a position of a corresponding sorting sliding slot 8; the tilting pan 314 of the tilting-pan trolley 3 is tilted, and the item falls into the sorting sliding slot 8 along the tilting pan 314 under the function of gravity, to complete sorting.

An initial position of the tilting pan 314 is horizontally titled; the lifting rod 313 lifts up. The locking wheel 315 is clamped on the rotation rod 319. Due to a tensile force of the spring 320 and blocking of the limiting rod 318, the rotation rod 319 enables the locking wheel to lock the lifting rod 313 to avoid falling. When the linear motor 7 carries the tilting-pan trolley 3 to walk to the unloading device 5, the corresponding unloading air cylinder 51 drives the unloading wheel 52 to be pushed out. When the tilting-pan trolley 3 continues to walk, the unloading wheel 52 and the rotation rod 319 are coplanar. The unloading wheel 52 blocks an end of the rotation rod 319. The rotation rod 319 rotates on the rotation shaft 317 upon the blocking, and the other end thereof moves out of the position of the locking wheel 315. The weight of the tilting pan 314 plus the weight of the commodity presses the lifting rod 313 thereof downward, and the commodity falls along the tilting pan 314. When the linear motor 7 carries the tilting-pan trolley 3 to continuously walk to the reset track 6, the reset wheel 316 at the lower end of the lifting rod 313 drives along a slope of the slope track 61, so that the lifting rod 313 thereof lifts up. When the locking wheel 315 is lifted up to be higher than the rotation rod 319, the rotation rod 319 locks the height of the rotation rod 313 again upon the tensile force of the spring 320 thereof, and the tilting pan is horizontally tilted again.

The apparatus is applicable to the following industries: shoes and clothing, books and periodicals, e-commerce, medicine, daily consumer goods and other small parcels application industries. Sortable item types include: small items, irregular shape items, and soft packaging items.

Apparatus performance: A tray-typed carrying structure is adopted, so that light and round commodities that are not adaptive for the cross-belt sorting machine to sort can be normally sorted, and the sorting adaptability is extremely strong.

The sorting efficiency of an adopted unique “one-trolley-two-pan” structure is twice as high as that of a cross-belt sorting machine with the same configuration, and when the main ring speed is 1.2 m/s, the sorting efficiency may reach 15400 pieces per hour. If a double-end package supply configuration is adopted, the maximum theoretical processing efficiency may reach 30800 pieces per hour.

The apparatus is operated in a low rate, which is more suitable for a manual package supply mode and does not require multi-stage package supply systems. At the same time, a mouth sliding slot and a track door frame are integrally designed, and thus the system has a compact structure and a flexible arrangement, reduces occupation of land, and reduces costs.

The linear motor is adopted for driving main line operation, and a pure mechanical structure design is adopted for a sorting bogie unloading and reset mechanism; and the whole set of apparatuses is extremely low in energy consumption.

When the tilting-pan typed sorting machine is used for unloading, the commodity inclinedly falls into the sliding slot along the tilting pan, the sorting is stable, and the commodity would not be easily damaged.

The aforementioned are only preferable embodiments of the present invention, and therefore, all equivalent variations or modifications made according to the constructions, features, and principles in the patent application scope of the present invention are included in the patent application scope of the present invention.

What is claimed is:

1. A tilting-pan typed sorting machine, comprising a frame body (1), a code reading device (4), an unloading device (5), a reset track (6), and a sorting sliding slot (8), wherein an operation track (2) is disposed on the frame body (1); the code reading device (4) is disposed above the operation track (2); the unloading device (5) is disposed below the operation track (2); the unloading device (5) comprises an air cylinder seat (50); the air cylinder seat (50) comprises two symmetrically disposed unloading air cylinders (51); a piston rod of each unloading air cylinder (51) is provided with an unloading wheel (52); the two unloading wheels (52) are disposed in parallel; the reset track (6) is disposed below the operation track (2); several tilting-pan trolleys (3) are disposed on the operation track (2); a side of the operation track (2) is further provided with a linear motor (7); and the sorting sliding slot (8) is disposed at two sides of the unloading device (5) of the operation track (2).

2. The tilting-pan typed sorting machine according to claim 1, wherein the tilting-pan trolley (3) comprises a trolley frame (301); four universal walking wheels (302) disposed at equal altitude and in parallel are disposed at lower parts of two ends of the trolley frame (301); two guiding wheels (303) are further disposed at a lower part of an end of the trolley frame (301); a joint bearing (304) is disposed at an upper part of the end of the trolley frame (301) having the guiding wheels (303); a linear motor secondary plate (305) is disposed on an inner side of the end of the trolley frame (301) having the guiding wheels (303); a tilting-pan seat (306), a right seat plate (307), and a left seat plate (308) are disposed on the trolley frame (301); the right seat plate (307) and the left seat plate (308) are disposed at two sides of the tilting-pan seat (306); two short connection rods (309) are movably hinged on the tilting-pan seat (306); a sliding seat (311) is disposed on both the right seat plate (307) and the left seat plate (308); a lifting rod (313) is disposed in the middle of the sliding seat (311); two buffers (312) are further disposed on the sliding seat (311); and the buffers (312) are symmetrically distributed at two sides of the lifting rod (313).

3. The tilting-pan typed sorting machine according to claim 2, wherein the lifting rod (313) is T-shaped; a T-shaped end of the lifting rod (313) is movably hinged with a long connection rod (310); an end of the long connection rod (310) is movably hinged with the short connection rod (309); and the long connection rod (310) is provided with a tilting pan (314).

4. The tilting-pan typed sorting machine according to claim 2, wherein a rotation shaft (317) and two limiting rods (318) are disposed at lower parts of both the right seat plate (307) and the left seat plate (308); the two limiting rods (318) are disposed at two sides of the rotation shaft (317); a rotation rod (319) is disposed at a lower end of the rotation shaft (317); a spring (320) is further disposed at the lower parts of the right seat plate (307) and the left seat plate (308); and the other end of the spring (320) is hinged with the rotation rod (319).

5. The tilting-pan typed sorting machine according to claim 1, wherein a locking wheel (315) and a reset wheel (316) are successively disposed at a lower end of the lifting rod (313) from top to bottom; a bearing is disposed both in the middle of the locking wheel (315) and in the middle of the reset wheel (316); and surfaces thereof are both made of an MC nylon material with lightweight and wear resistance.

6. The tilting-pan typed sorting machine according to claim 2, wherein the tilting-pan trolleys (3) are head-to-tail connected through the joint bearing (304).

7. The tilting-pan typed sorting machine according to claim 3, wherein the tilting pans (314) on each tilting-pan trolley (3) are all disposed in a symmetrical pair.

8. The tilting-pan typed sorting machine according to claim 2, wherein the walking wheels (302) at the two ends are four universal wheels disposed at equal altitude and in parallel.

9. The tilting-pan typed sorting machine according to claim 1, wherein the reset track (6) consists of two slope tracks disposed in parallel.
